(19) United States
(12) Patent Application Publication
(10) Pub. No.: US 2025/0243890 A1
(43) Pub. Date: Jul. 31, 2025

(54) FASTENING STRUCTURE

(71) Applicant: Isuzu Motors Limited, Yokohama-shi (JP)

(72) Inventors: Yutaro TAKAKURA, Fujisawa-shi (JP); Akio OTAGIRI, Fujisawa-shi (JP); Kazuhisa KOHARA, Fujisawa-shi (JP)

(73) Assignees: Isuzu Motors Limited, Yokohama-shi (JP); ., (omitted)

(21) Appl. No.: 19/039,793

(22) Filed: Jan. 29, 2025

(30) Foreign Application Priority Data
Jan. 30, 2024 (JP) 2024-011926

(51) Int. Cl. F16B 35/04; F16M 13/02

(52) U.S. Cl. CPC F16B 35/04; F16M 13/02

(57) ABSTRACT

An object of the present disclosure is to provide a structure in which fretting does not occur in a fastening structure in which a plurality of members are fastened to each other with a fastening member. Thus, the fastening structure includes: a first member that includes a through hole; a second member, and a fastening member that is inserted through the through hole and fastens the first member and the second member, in which rigidity of a portion of the first member around the through hole is lower than rigidity of a portion of the second member fastened with the fastening member.

### CROSS REFERENCE TO RELATED APPLICATIONS

This application claims the benefit of priority of Japanese Patent Application No. 2024-011926, filed on Jan. 30, 2024, the contents of which are incorporated by reference as if fully set forth herein in their entirety.

### TECHNICAL FIELD

The present disclosure relates to a fastening structure for fastening a plurality of members with a fastening member such as a bolt.

### BACKGROUND ART

FIG. 7 is a perspective view of a schematic structure in which compressor 103 is attached to engine 101, FIG. 8 is the side view, and FIG. 9 is the front view. Hanger 102 for suspension is attached to engine 101. Bracket 104 is attached to compressor 103, and is fastened to a side face of hanger 102 with bolt 105. Note that details of other fastening portions for attaching compressor 103 to engine 101 are omitted.

### SUMMARY OF INVENTION

### Technical Problem

Repeating the operation of vehicle, that is, the use of the engine may result in wear called fretting on the contact surface between bracket 104 and hanger 102. Fretting is wear caused by the members rubbing with each other.

To prevent fretting, generally, (1) increasing the surface pressure between members by increasing the number of fastening members, (2) increasing the surface pressure between members by increasing the fastening torque of the fastening member, (3) forming a protective layer to prevent wear on the fastening surface between members, (4) applying a lubricant to prevent wear to the fastening surface between members, or the like is considered. However, all measures increase the cost of fastening. Further, the measures may not be feasible depending on the shape, material, or the like of the member.

The inventors of the present disclosure have found the following main cause of fretting in a fastening structure in which a plurality of members is fastened with a fastening member.

FIG. 10 schematically illustrates a cross section of a fastening structure. Through holes 62 and 72 are formed in first member 61 and second member 71, respectively, and both members 61 and 71 are fastened with bolt 81 inserted through holes 62 and 72, and nut 82

Even though the surfaces of both members 61 and 71 facing each other are designed to make surface contact with each other, when the bolt is firmly tightened as illustrated in FIG. 10, the contact surfaces of both members 61 and 71 possibly do not make surface contact with each other due to manufacturing errors or assembly errors in members 61 and 71, only contact portions 63 and 73 of parts of both members 61 and 71 come into contact with each other, and gap G is possibly formed at other portions.

When both members 61 and 71 are placed in a vibration environment in such a fastened state, contact portions 63 and 73 are unlikely to relatively move, while portions 64 and 74 interposing gap G are likely to relatively move. The relative movement of both portions 64 and 74 causes both portions 64 and 74 to come into contact and rub with each other, thus causing fretting.

An object of the present disclosure is to provide a structure in which fretting does not occur in a fastening structure in which a plurality of members are fastened to each other with a fastening member.

### Solution to Problem

A fastening structure of the present disclosure includes: a first member that includes a through hole; a second member; and a fastening member that is inserted through the through hole and fastens the first member and the second member, in which rigidity of a portion of the first member around the through hole is lower than rigidity of a portion of the second member fastened with the fastening member.

### Advantageous Effects of Invention

According to the present disclosure, a member fastened with the fastening member is deformed by the fastening force of the fastening member, and fastened members make surface contact with each other, thereby suppressing occurrence of fretting.

### BRIEF DESCRIPTION OF DRAWINGS

FIG. 1 illustrates a fastened state of a first member and a second member;

FIG. 2 is a cross-sectional view of the first member;

FIG. 3 illustrates a first variation;

FIG. 4 illustrates a second variation;

FIG. 5 is a cross-sectional view of a bracket;

FIG. 6 illustrates a fastened state of the bracket and a hanger;

FIG. 7 illustrates a state in which a compressor is attached to an engine;

FIG. 8 is a side view of FIG. 7;

FIG. 9 is a front view of FIG. 7; and

FIG. 10 illustrates related art.

### DESCRIPTION OF EMBODIMENTS

Hereinafter, a fastening structure according to an embodiment of the present disclosure will be described in detail with reference to the drawings. Note that each of the embodiments described below shows a comprehensive or specific example. Each drawing is a schematic diagram and is not necessarily a strict illustration. Further, in the drawings, substantially the same components are denoted by the same reference numerals, and redundant descriptions may be omitted or simplified.

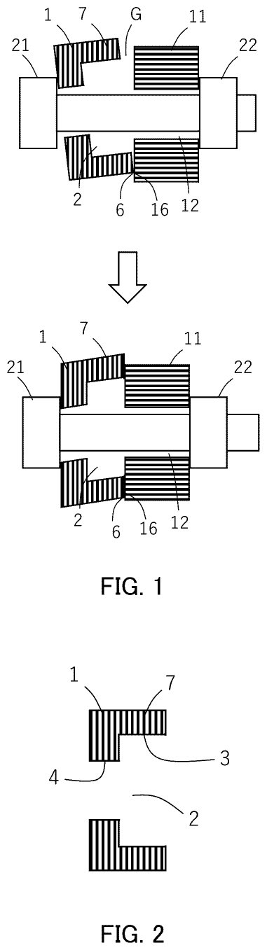

FIG. 1 illustrates a schematic structure in which first member 1 and second member 11 according to the present embodiment are fastened with bolt 21 and nut 22, which are kinds of fastening members. The upper diagram in FIG. 1 illustrates a state before tightening (lightly tightening) the bolt, and the lower diagram in FIG. 1 illustrates a state after tightening (firmly tightening) the bolt. Further, FIG. 2 illustrates first member 1.

Through holes 2 and 12 are respectively formed in first member 1 and second member 11, and bolt 21 is inserted through through holes 2 and 12. The surfaces of first member 1 and second member 11 facing each other are not parallel, and contact portion 6 of first member 1 and contact portion 16 of second member 11 make contact with each other around through holes 2 and 12, and gap G is formed at other portions.

Through hole 2 of first member 1 includes large diameter portion 3 on a side close to second member 11 (right side in the drawing) and small diameter portion 4 on a side apart from second member 11 (left side in the drawing). Thus, in the portion of first member 1 around through hole 2, the portion facing second member 11 forms thin portion 7, the rigidity of which is lower than that of second member 11.

As illustrated in the lower diagram in FIG. 1, when bolt 21 and nut 22 are firmly tightened, thin portion 7 of first member 1 is deformed by the fastening force, and first member 1 and second member 11 come into surface contact with each other around through holes 2 and 12. The surface contact of both members 1 and 11 increases the frictional force between both members 1 and 11, and thus both members 1 and 11 are unlikely to move relative to each other even when both members 1 and 11 are placed in a vibrating environment, so that occurrence of fretting can be suppressed.

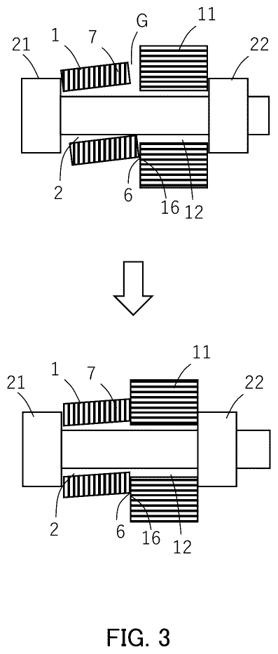

FIG. 3 illustrates a first variation of first member 1. In this variation, instead of forming a large-diameter portion and a small-diameter portion in through hole 2, first member 1 includes thin portion 7 around through hole 2 (upper diagram in FIG. 3). Thus, thin portion 7 of first member 1 is deformed by the fastening force when bolt 21 and nut 22 are firmly tightened, and first member 1 and second member 11 come into surface contact with each other around through holes 2 and 12 (lower diagram in FIG. 3).

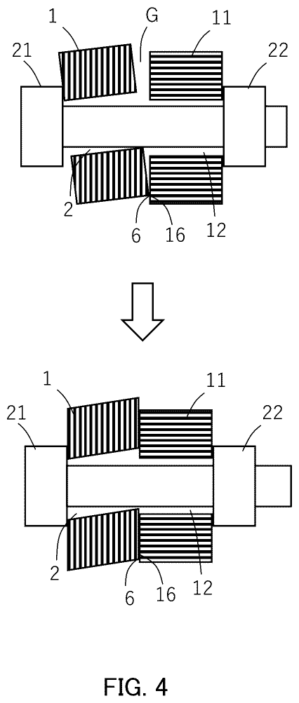

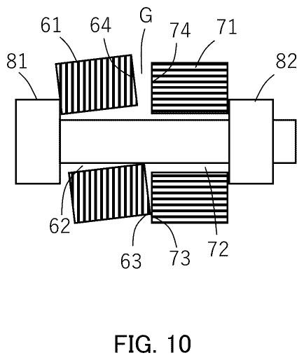

FIG. 4 illustrates a second variation of first member 1. In this variation, the thickness of the portion of first member 1 around through hole 2 is the same as the example of related art (FIG. 10), but as the material of first member 1, a material having low rigidity, such as aluminum alloy, is employed (upper diagram in FIG. 4). Thus, when bolt 21 and nut 22 are firmly tightened, second member 11 is not deformed, whereas first member 1 is deformed by the fastening force, and first member 1 and second member 11 come into surface contact with each other around through holes 2 and 12 (lower diagram in FIG. 4).

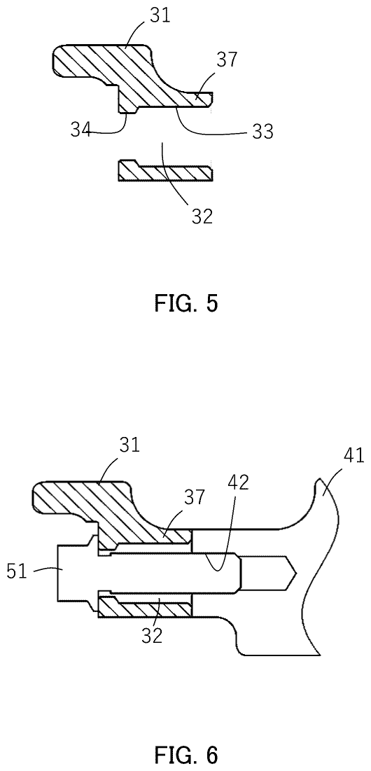

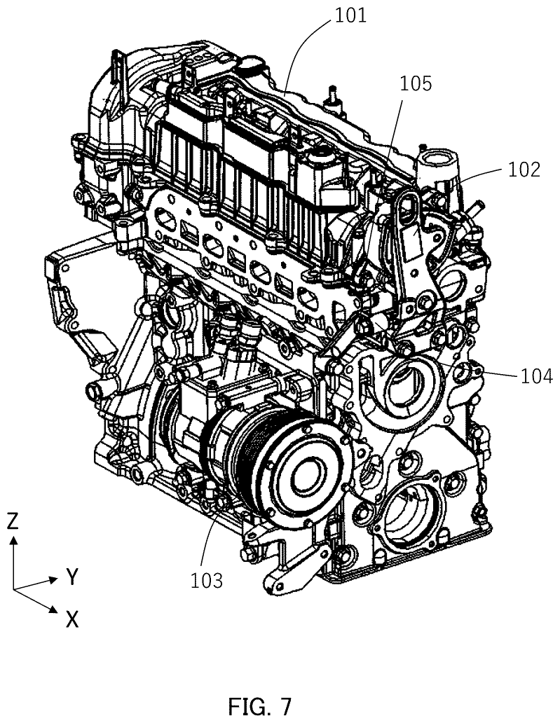

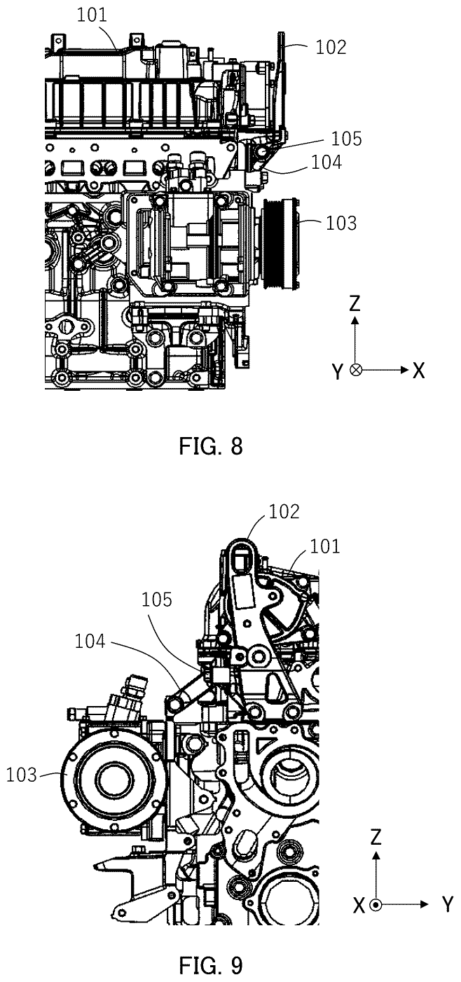

FIG. 5 is a cross-sectional view of a portion of bracket 31 to be fastened. Bracket 31 is used when a compressor is attached to an engine, and is attached to the engine. Through hole 32 is formed in bracket 31, and large-diameter portion 33 and small-diameter portion 34 are formed in through hole 32. Thin portion 37 is formed around large-diameter portion 33.

The inner diameters of large-diameter portion 33 and small-diameter portion 34 and the outer diameter of thin portion 37 are designed based on the material or the like of bracket 31. For example, in a case where the material of bracket 31 is FC250 cast iron, it is preferred that the inner diameter of large-diameter portion 33 be 15 mm, the inner diameter of small-diameter portion 34 be 11.8 mm, the outer diameter of thin portion 37 be 22 mm, and the thickness of thin portion 37 be 3.5 mm.

FIG. 6 is a cross-sectional view of a structure in which bracket 31 (first member) and hanger 41 (second member) for suspending an engine (not shown) are fastened with bolt 51. Female screw 42 with which bolt 51 is threadedly engaged is formed in hanger 41. When bracket 31 and hanger 41 are fastened with bolt 51, thin portion 37 around through hole 32 is deformed by the fastening force, and bracket 31 and hanger 41 come into surface contact with each other. Thus, occurrence of fretting on the contact surface between bracket 31 and hanger 41 can be suppressed.

As described above, according to the present disclosure, the member fastened with the fastening member is deformed by the fastening force of the fastening member and the fastened members make surface contact with each other, thereby suppressing occurrence of fretting.

### INDUSTRIAL APPLICABILITY

The present disclosure can be suitably applied when a plurality of members is fastened with a fastening member.

### REFERENCE SIGNS LIST

1 First member
2 Through hole
3 Large-diameter portion
4 Small-diameter portion
6 Contact portion
7 Thin portion
11 Second member
12 Through hole
16 Contact portion
21 Bolt
22 Nut

1. A fastening structure, comprising:
a first member that includes a through hole;
a second member; and
a fastening member that is inserted through the through hole and fastens the first member and the second member, wherein
rigidity of a portion of the first member around the through hole is lower than rigidity of a portion of the second member fastened with the fastening member.

2. The fastening structure according to claim 1, wherein
the second member includes a through hole, and
the fastening member is inserted through the respective through holes of the first member and the second member.

3. A fastening structure, comprising:
a first member that includes a through hole;
a second member; and
a fastening member that is inserted through the through hole and fastens the first member and the second member, wherein
the first member and the second member make surface contact with each other by at least one of the first member and/or the second member being deformed by a fastening force of the fastening member.

4. The fastening structure according to claim 1, wherein
the first member is a bracket for attaching a compressor to an engine, and
the second member is a hanger for suspending the engine.

5. The fastening structure according to claim 1, wherein
the portion of the first member around the through hole is formed as a thin portion.

6. The fastening structure according to claim 1, wherein
the portion of the first member around the through hole is formed as a thin portion by forming a portion of the through hole close to the second member as a large-diameter portion and forming a portion of the through hole apart from the second member as a small-diameter portion.

7. The fastening structure according to claim 1, wherein
a material of the portion of the first member around the through hole has lower rigidity than a material of the portion of the second member fastened with the fastening member.
